(19) United States
(12) Patent Application Publication
(10) Pub. No.: US 2003/0081564 A1
(43) Pub. Date: May 1, 2003

(54) Wireless transmission and recording of images from a video surveillance camera

(76) Inventor: James C. K. Chan, Unionville (CA)

Correspondence Address: Timothy J. Sinnott, Bereskin & Parr, Box 401, 40 King Street West, Toronto, ON, M5H 3Y2, CA

(21) Appl. No.: 09/984,240

(22) Filed: Oct. 29, 2001

(51) Int. Cl. H04Q 7/00

(52) U.S. Cl. 370/328; 370/389

(57) ABSTRACT

This invention relates to a wireless video surveillance system and a method form image data transmission and image processing. Image data is captured by an image sensor and transmitted wirelessly to a computer making use of a priori knowledge of the dimensions of the image. Image processing, comprising error correction and color interpolation, is then performed on the image data. The image data is then displayed on a computer display for visual inspection and stored on a storage means.

### FIELD OF THE INVENTION

The present invention relates to video surveillance systems, and more particularly, to a system and method for wireless transmission and recording of image data from an image sensor.

### BACKGROUND OF THE INVENTION

Conventional video surveillance systems usually consist of a video camera, a video cassette recorder (VCR) hard-wired to the video camera, and a monitor. In these systems it is necessary to periodically change the video tapes in the VCR, which tends to be cumbersome and expensive. These video surveillance systems impose limitations upon the location of the video camera since the video camera must be connected to the VCR by a cable. In addition, there is considerable work involved in installing such a video surveillance system.

Accordingly, there is a movement towards wireless video surveillance systems, which use an RF (radio frequency) transmitter for transmitting signals from a camera to a receiving station. Wireless video surveillance systems are easier to install than conventional surveillance systems and provide greater flexibility in video camera placement since it is not necessary to hard-wire the camera to the receiver. However, these wireless video surveillance systems continue to utilize VCRs to record the images generated by the video camera. Consequently, the costs associated with known wireless surveillance systems are still relatively high.

In addition, prior art wireless video surveillance systems are prone to noise corruption in the received video signal. This noise corruption adversely affects the quality of the images that are generated from the received video signal. For instance, some images may have erroneous pixels due to the noise corruption. This is troublesome since objects in images with erroneous pixels may be difficult to observe.

Another consideration in video systems is the usage of horizontal and vertical pulses. These pulses are embedded in video data to reconstruct each image frame contained in the video data. The vertical pulse is used to identify the end of the video data for a given image frame and the horizontal pulse is used to identify the end of the video data for a given row in an image frame. These pulses are sent with the video data and must be detected in a receiver that processes the transmitted video data. However, the transmission of these pulses decreases the efficiency of the video system.

### SUMMARY OF THE INVENTION

In one aspect, the present invention is a wireless video surveillance system, comprising an image sensor for capturing images, a wireless transmitter operatively coupled to the image sensor, a wireless receiver, and a computer operatively coupled to the receiver. The image sensor comprises a plurality of sensor elements arranged in an array having a number of rows and a number of columns. The wireless transmitter reads the image data and transmits the image data in a plurality of data packets. Each of the data packets has a data field comprising a portion of the image data and a header comprising information about the size of the portion of image data. The first transmitted data packet further comprises information about the number of rows and the number of columns of the array. The wireless receiver receives and reads the plurality of data packets. The computer processes and stores the plurality of data packets and generates and stores an image representative of the captured image data. The computer utilizes the number of rows and the number of columns to facilitate the reception of the plurality of data packets and the generation of the image.

In a second aspect, the present invention provides a method of performing wireless video surveillance, comprising the steps of:

a) capturing image data utilizing an image sensor having a plurality of sensor elements arranged in an array having a number of rows and a number of columns;

b) reading and transmitting the image data in a plurality of data packets utilizing a wireless transmitter, wherein each of the data packets has a data field comprising a portion of the image data and a header comprising information about the size of the portion of image data, wherein the first transmitted data packet further comprises information about the number of rows and the number of columns;

c) receiving the plurality of data packets; and,

d) processing the plurality of data packets and generating an image representative of the captured image data,

wherein, the number of rows and the number of columns are used in receiving the plurality of data packets and generating the image.

In another aspect, the present invention provides a system for performing error correction on transmitted data packets to correct data packets having an erroneous portion of image data wherein each packet has a header and a data field. The system comprises a storage means for storing the transmitted data packets and an error correction module operatively coupled to the storage means. The error correction module retrieves a data packet, removes the header of the data pocket, and determines an expected number of image data bytes that should be contained in the data field of the data packet. The module then compares the expected number of image data bytes to the size of the portion of image data contained in the data packet. If the comparison is true, the portion of image data is stored and, if the comparison is false, the erroneous portion of image data is replaced with an error-free portion of image data from at least one previously transmitted data packet and stored. The error-free portion of image data is similarly representative of the information that was represented by the erroneous portion of image data.

In a further aspect, the present invention provides a method of performing error correction on transmitted data packets to correct data packets having an erroneous portion of image data wherein each packet has a header and a data field, the method comprising the steps of:

a) removing the header of a data packet;

b) determining an expected number of image data bytes that should be contained in the data field of the data packet;

c) comparing the expected number of image data bytes to the size of the portion of image data contained in the data packet;

d) storing the portion of image data if the comparison step (c) is true; and,

e) identifying an erroneous data packet if the comparison in step (c) is false, replacing the erroneous portion of image data with an error-free portion of image data from at least one previously transmitted data packet and storing the replaced portion of image data,

wherein, the error-free portion of image data is similarly representative of the information that was represented by the erroneous portion of image data.

### BRIEF DESCRIPTION OF THE DRAWINGS

For a better understanding of the present invention and to show more clearly how it may be carried into effect, reference will now be made, by way of example only, to the accompanying drawings which show a preferred embodiment of the present invention and in which:

FIG. 1 is a block diagram of a preferred embodiment of a wireless video surveillance system made in accordance with the present invention;

FIG. 2a is a schematic of an image sensor;

FIG. 2b is a schematic of sensor elements contained in the image sensor of FIG. 2a;

FIG. 3 is a block diagram of a preferred embodiment of a circuit for the transmitter of the present invention;

FIG. 4 is a block diagram of a preferred embodiment of a circuit for the receiver of the present invention;

FIG. 5a is a block diagram showing data transmission between the wireless transmitter and the wireless receiver;

FIG. 5b is a data structure diagram showing the components of a frame header packet;

FIG. 5c is a data structure diagram showing the components of a data packet;

FIG. 5d is an example of the rows of image data which are contained in the transmitted data packets;

FIG. 6 is a flow chart of the main module of the software program of the present invention;

FIG. 7 is a flow chart of the image processing module of the software program of the present invention;

FIG. 8 is a flow chart of the error correction module of the software program of the present invention;

FIG. 9 is a flow chart of a preferred embodiment of the color enhancement module of the software program of the present invention; and,

FIG. 10 is a block diagram of an alternative embodiment of the transmitter circuit of the present invention.

### DETAILED DESCRIPTION OF THE INVENTION

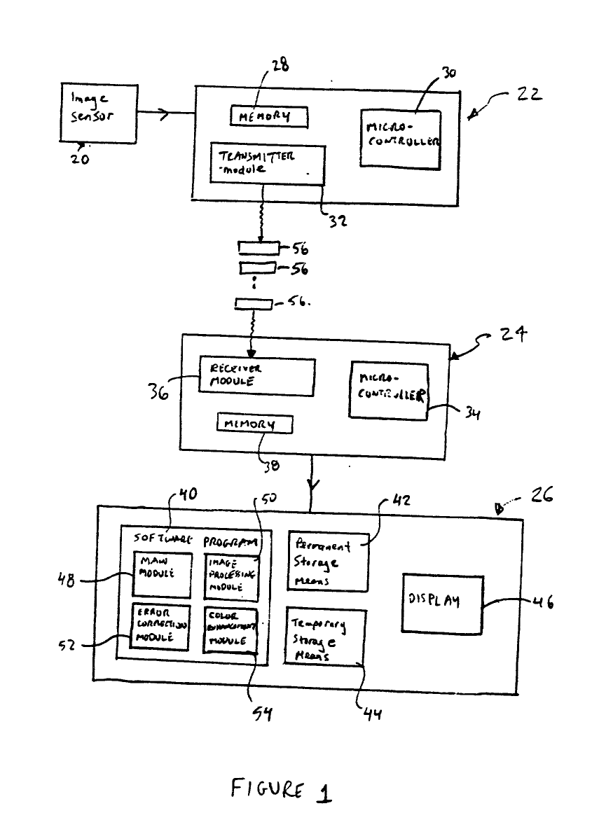

Reference is first made to FIG. 1, which shows a preferred embodiment of a wireless video surveillance system 10 of the present invention. The wireless video surveillance system 10 comprises an image sensor 20 for generating image data, a wireless transmitter 22 operatively coupled to the image sensor 20, a wireless receiver 24 for receiving image data transmitted by the wireless transmitter 22, and a computer 26 operatively coupled to the receiver 24.

The wireless transmitter 22 comprises a memory 28, a micro-controller 30 and a transmitter module 32. The wireless receiver 24 comprises a receiver module 34, a micro-controller 36 and a memory 38. The computer 26 comprises a software program 40, a permanent storage means 42, temporary storage means 44 and a display 46. The software program 40 comprises a main module 48, an image processing module 50, an error correction module 52 and a color enhancement module 54.

In operation, the image sensor 20 is adapted to capture image data of a scene in the field of view of the image sensor 20. This image data may be referred to as a frame of image data. The image data is then sent from the image sensor 20 to the wireless transmitter 22 where the image data is stored in the memory 28. The image data is then sent to the transmitter module 32 for radio frequency (RF) transmission to the wireless receiver 24. Radio transmission is preferably done via data packets 56. As the data packets 56 are received, they are stored in the memory 38 of the wireless receiver 24. Once all of the data packets 56 containing the image data for the frame have been received, the data packets 56 are sent to the temporary storage means 44 on the computer 26. The software program 40 then processes the image data via the image processing module 50. More specifically, error correction is applied to the image data via the error correction module 52 to obtain error free image data. Color enhancement is then applied to the error free image data via the color enhancement module 54. The color-enhanced, error-corrected image data is then displayed on the display 46 for visual inspection and stored on the permanent storage means 42 for inspection at a later date.

Transmitter module 32 and receiver module 34 are preferably Bluetooth devices which adhere to the Bluetooth standard which is a global standard that facilitates wireless data and voice communication between both stationary and mobile devices. The Bluetooth standard defines a short range (approximately 10 m) or a medium range (approximately 100 m) radio link capable of data transmission up to a maximum capacity of 723 KB per second in the unlicensed industrial, scientific and medical band which is between 2.4 to 2.48 GHz. Bluetooth devices may be adapted to easily set up a point-to-multi-point network in which one Bluetooth device communicates with several Bluetooth devices or a point-to-point network in which two Bluetooth devices communicate with each other. Thus, Bluetooth devices could be used to set up a network of image sensors 20 that could communicate with the computer 26. However, for simplicity, the present invention will be described using only one image sensor 20. Another possibility is to connect a point-to-multipoint network with a point-to-point network. Furthermore, communication between Bluetooth devices is not limited to line-of-sight communication. Bluetooth devices also have built-in security to prevent eavesdropping or the falsifying of data. All of these features are suitable for the wireless video surveillance system 10.

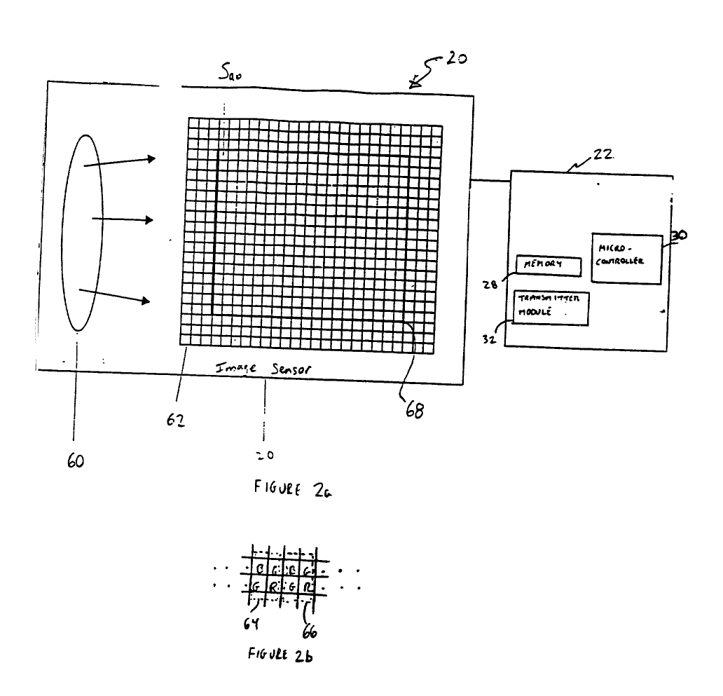

Referring to FIG. 2a, the image sensor 20 is preferably a CMOS (Complementary Metal-Oxide Semiconductor) image sensor, such as a National Semiconductor LM 9627 image sensor, which captures still image data or motion image data and converts the captured data to a digital data stream. An integrated programmable smart timing and control circuit allows for the adjustment of integration time, active window size, gain and frame rate. Alternatively, a CCD camera may be used as the image sensor 20. However, a CCD camera will increase the cost of the wireless video surveillance system 10.

The image sensor 20 captures image data by using an optical assembly 60 which acts as a lens for the image sensor 20 and an active pixel array 62 (not shown to scale) which comprises a plurality of sensor elements. Each sensor element of the active pixel array 62 captures light according to a specific color filter. Sensor elements on even rows of the active pixel array 62 contain either a blue or a green color filter. Sensors on odd rows of the active pixel array 62 contain either a green or a red color filter. This arrangement is depicted in FIG. 2b for two arbitrary rows of sensor elements. The outputs of groups of four adjacent sensor elements such as adjacent sensor element group 64 or 66 are then combined by the color enhancement module 54 to produce a pixel in the final image as will be described later.

During image data capture, each sensor element in the active pixel array 62 will contain a voltage that corresponds to the amount of color, in the scene for which the image is being captured, that corresponds to the color filter of the sensor element. For example, if sensor element Sao has a blue color filter, the voltage contained in that sensor element would indicate the amount of blue color in the scene corresponding to the location of the sensor element Sₐ₀. The voltages from each of the sensor elements in the active pixel array 62 are represented by an a 8 bit (i.e. 1 byte) value.

In the preferred embodiment, the active pixel array 62 has a size of 648 rows by 488 columns (i.e. 648×488). However, the active pixel array 62 can have an image array 68 (not shown to scale in FIG. 2a) defined within it for which image data is recorded. Accordingly, the maximum size of the image array 68 is the size of the active pixel array 62. In the present invention, the size of the image array 68 is preferably chosen to be either 100 rows by 100 columns (100×100) or 400 rows by 300 columns (400×300) anywhere within the active pixel array 62. The size and the location of the image array 68 is specified via a program interface which is provided to the image sensor 20.

Once a frame of image data has been captured by the image sensor 20, the image data contained in the image array 68 is read and sent to the memory 28. The image data will be read one sensor element at a time, starting from the leftmost sensor element in the topmost row ending with the rightmost sensor element in the topmost row. The image data from each row thereafter will be read in a similar fashion until all the image data has been read.

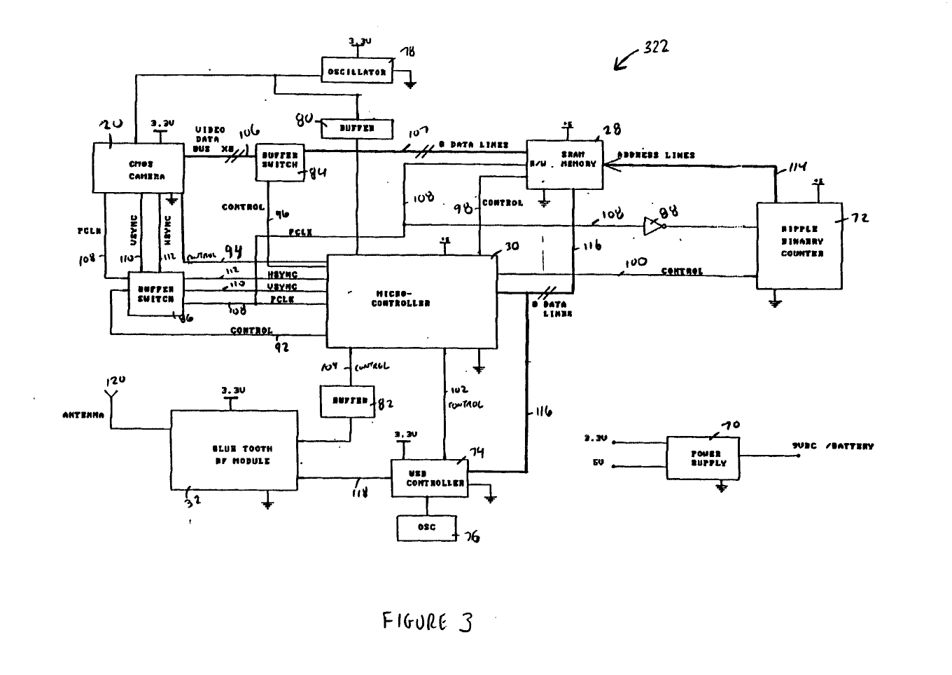

Referring now to FIG. 3, shown therein is a preferred embodiment of a transmitter circuit 322 to implement the wireless transmitter 22. The transmitter circuit 322 comprises the image sensor 20, the transmitter module 32, the micro-controller 30 and the memory 28. The transmitter circuit 322 further comprises a power supply 70, a binary ripple counter 72, a USB controller 74, oscillators 76 and 78, buffers 80 and 82, buffer switches 84 and 86 and an inverter 88.

The power supply 70 is adapted to receive power from a 9 Volt supply and provide 3.3 and 5 Volt power supply lines to power the various components of the transmitter circuit 322. The buffers 80 and 82 and the buffer switches 86 and 88 are used to couple circuit components which are powered at different voltage supply levels. The buffer switches 86 and 88 also have another input which controls whether data transmission through the buffer is enabled. For instance, CONTROL signal 96 enables or disables the flow of data through the buffer switch 84. The oscillators 76 and 78 are used to provide clock signals to the image sensor 20, the micro-controller 30 and the USB controller 74.

The micro-controller 30 is preferably a PIC18C442 micro-controller made by MicroChip Technologies™. The micro-controller 30 controls the operation of the transmitter circuit 322. In particular, the micro-controller 30 controls and synchronizes the operation of the image sensor 20, the buffer switches 84 and 86, the memory 28, the binary ripple counter 72, the USB controller 74 and the transmitter module 32 via CONTROL signals 92, 94, 96, 98, 100, 102 and 104. The functionality of the micro-controller 30 is programmed using Assembler language. The micro-controller 30 is adapted to program the functionality of the image sensor 20 via CONTROL signal 94. In particular, the micro-controller 30 can program the size of the image array 68 and the location of the image array 68 within the active pixel array 62.

The image data captured by the image sensor 20 is sent to the buffer switch 84 via an 8 bit video data bus 106. The coordination of the image data transfer via the video data bus 106 is accomplished by a PCLK signal 108 which is generated by the image sensor 20. The micro-controller 30 also facilitates this transfer of image data through the buffer switch 84 to the memory 28 via CONTROL signal 96 which enables data transmission through the buffer switch 84. During image data transmission, the PCLK signal 108 is a pulse train of 0's and 1's. A transition from a 0 to a 1 indicates that image data from a given sensor element in the image sensor 20 is being read. The micro-controller 30, memory 28 and the ripple binary counter 72 also receive the PCLK signal 108 to synchronize reading image data from a sensor element in the image sensor 20.

The image sensor 20 also generates a VSYNC signal 110 and an HSYNC signal 112 which are sent through the buffer switch 86 to the micro-controller 30. In standard video systems, the HSYNC signal 112 is used to partition rows of image data and the VSYNC signal 114 is used to partition frames of image data. In the present invention, the HSYNC signal 112 is not used but the VSYNC signal 110 is used to indicate to the micro-controller 30 that all of the image data corresponding to the captured image has been read from the image sensor 20. This is the only time that VSYNC information is used in the subject invention.

The ripple binary counter 72 is preferably a 74VHC4040 ripple binary counter made by Toshiba™. The ripple binary counter 72 is adapted to provide address values to the memory 28 via address lines 114. The ripple binary counter 72 generates an address value when the PCLK signal 108 makes a transition from high to low since the PCLK signal is connected to the ripple binary counter 72 via the inverter 88. In this fashion, the ripple binary counter 72 is adapted to provide an address value to the memory 28 before the memory 28 receives an image data value from the image sensor 20. This occurs when the micro-controller 30 is issuing a write command (i.e. during a write operation). The address value provided by the binary ripple counter 72 is incremented upon every write command given to the memory 28. Alternatively, the address value provided by the binary ripple counter 72 can be decremented on every read command given to the memory 28. These read and write commands are provided by the CONTROL signals 98 and 100 from the micro-controller 30.

The memory 28 is preferably an ASC7C1024 SRAM memory made by Alliance Semiconductor™. The memory 28 is adapted to receive an image data value from the image sensor 28 via eight 1-bit data lines 107 on every low to high transition of the PCLK signal 108 when the micro-controller 30 is issuing a write command. The synchronization of the PCLK signal 108 and the CONTROL signal 98 allows the memory 28 to save this image data value at an address value that had previously been received from the ripple binary counter 72.

The entire image array 68 is read from the image sensor 20 and stored in the memory 28 in this manner. The VSYNC signal 110 then indicates to the micro-controller 30 that all of the image data from the image array 68 has been read. At this point, the micro-controller 30 then begins a read operation to transfer the image data for the current image frame from the memory 28 to the USB controller 74 via eight 1-bit data lines 116. Accordingly, the image data is transmitted one byte at a time. The micro-controller 30 also instructs the image sensor 20 to capture another frame of image data.

The USB controller 74 is preferably an N9603 USB controller made by National Semiconductor™. A USB (Universal Serial Bus) is a daisy chain connected, serial bus which may operate at speeds of up to 12 MB per second. The USB is used to allow various hardware devices to communicate with one another. Accordingly, the USB controller 74 coordinates data transmission on the USB. Alternatively, a UART (Universal Asynchronous Receiver Transmitter) may be used to facilitate data communication between the various hardware devices. A UART operates at slower speeds than a USB controller, however, if data compression were used on the image data then the usage of a UART would be more feasible. This is advantageous since some micro-controllers include a UART.

The USB controller 74 facilitates the transfer of image data to the transmitter module 32 via a USB 2 bit data line 118. The USB controller 74 transfers image data 1 byte at a time, however, the USB 2 bit data line 118 provides fast data transmission at rates of up to 723 KB per second. The micro-controller 30 synchronizes this image data transfer through CONTROL signal 102. During this read operation, the image data is also sent to the micro-controller 30 so that the micro-controller 30 knows when to stop this read operation.

The transmitter module 32 is preferably an ROK101007 Bluetooth module made by Ericsson™. The operation of the transmitter module 32 is synchronized by the CONTROL signal 104 sent from the micro-controller 30. The transmitter module 32 transmits data packets to the receiver module 34 of the wireless receiver 24 via an antenna 120. The data packets are constructed, one byte at a time, according to the Bluetooth standard which is described in more detail below. During data packet transmission, there is a handshaking process occurring between the transmitter module 32 and the receiver module 34. In particular, the transmitter module 32 must receive an acknowledgement from the receiver module 34 which indicates that the receiver module 34 is ready to receive more data.

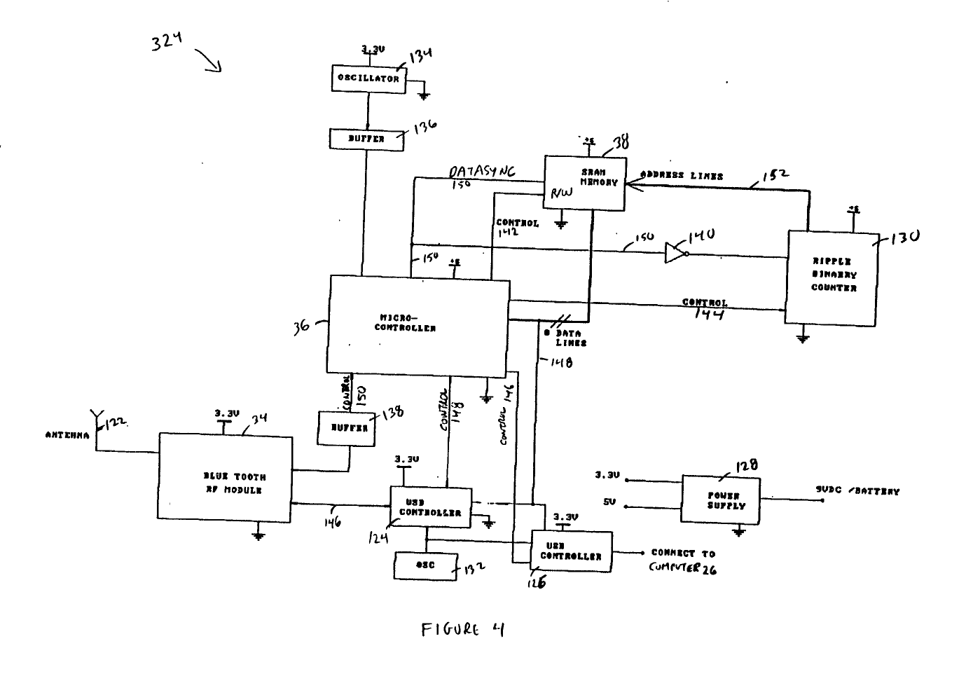

Referring now to FIG. 4, shown therein is a preferred embodiment of the wireless receiver 24 comprising receiver circuit 324. The receiver circuit 324 comprises an antenna 122, the receiver module 34, the micro-controller 36 and the memory 38. The receiver circuit 324 further comprises USB controllers 124 and 126, a power supply 128, a binary ripple counter 130, oscillators 132 and 134, buffers 136 and 138 and an inverter 140. The same chips have been used for the circuit components that are common to both the receiver circuit 324 and the transmitter circuit 322. As has been described for the transmitter circuit 322, the power supply 128 is adapted to receive power from a 9 Volt supply and provide 3.3 and 5 Volt power supply lines to power the various circuit components on the receiver circuit 324. In addition, the buffers 136 and 138 are used to couple circuit components which are powered at different voltage supply levels. Furthermore, the oscillators 132 and 134 are used to provide clock signals to the micro-controller 36 and the USB controllers 124 and 126.

The micro-controller 36 controls the operation of the receiver circuit 324. In particular, the micro-controller 36 controls and synchronizes the operation of the memory 38, the binary ripple counter 130, the USB controllers 124 and 126 and the receiver module 34 via CONTROL signals 142, 144, 146 and 148 and DATASYNC signal 150. In particular, the micro-controller 36 facilitates the transfer of data packets from the receiver module 34 through the USB controller 124 to the memory 38 and from the memory 38 through the USB controller 126 to the computer 26. To facilitate the transfer of these data packets, the micro-controller 36 does not use the HSYNC and VSYNC pulses that conventional video systems use. Rather, the micro-controller 36 checks the first data packet that is received from the transmitter module 32 for a given image frame to determine the size of the image array 68 from which the image data was originally obtained. This size information is used to determine how many data packets must be received from the transmitter module 32. The size information is also used to facilitate the transfer of the data packets between various circuit components on the receiver circuit 324.

The receiver module 34 is preferably an ROK101007 Bluetooth module made by Ericsson™. The receiver module 34 receives data packets from the transmitter module 32 via the antenna 122. Before any data packets are transmitted from the transmitter module 32 to the receiver module 34, the receiver module 34 will have to establish an RF connection with the transmitter module 34. Once a connection is established, if no data packets are received during a preset time, another attempt at establishing a connection will be made. Otherwise, if data packets are received, the data packets are then sent to the USB controller 124, one byte at a time, via a high speed USB 2 bit data line 146. The USB controller 124 then sends the data packets to the memory 38 for storage via eight 1-bit data lines 148. This write operation is facilitated by CONTROL signals 150, 148, 144 and 142 as well as DATASYNC signal 150.

If the time to receive all of the data packets for a given image frame has expired, the receiver module 34 will send an acknowledgement to the transmitter module 32 to indicate that all of the data packets for a given image frame have been received as long as ⅓ or more of the data packets for the image frame have been received. Accordingly, in the case where at least ⅓ of the data packets have been received, but not all of the data packets for a given image frame have been received, an incomplete image may be reconstructed by the software program 40.

The ripple binary counter 130 is adapted to provide address values to the memory 38 via address lines 152 at which data is either read from or written to the memory 38. The ripple binary counter 130 will provide an address value on each high to low (i.e. 1 to 0) transition of the DATASYNC signal 150 (due to the inverter 140) when the CONTROL signal 144 is indicating that a read or write operation is currently being done. These address values will be incremented during a write operation and decremented during a read operation.

The memory 28 is adapted to receive one byte of a data packet from the USB controller 124 during a write operation. The memory 28 is further adapted to provide one byte of a data packet value to the USB controller 126 during a read operation. The data transfer is facilitated by eight 1-bit data lines 148. The CONTROL signal 142 from the micro-controller 36 determines whether a read operation or a write operation is being performed as well as whether data is being received from the USB controller 124 or whether data is being sent to the USB controller 126. Furthermore, the DATASYNC signal 150 is used to synchronize the actual time at which data is either read from or written to the memory 38.

After all of the data packets for a given image frame have been stored in the memory 38, the data packets are transferred from the memory 38 to the computer 26 via the USB controller 126. In particular, the data packets are sent to the temporary storage means 44, such as the RAM, of the computer 26. During this read operation, the data packets are also sent to the micro-controller 36 so that the micro-controller 36 will know how much data is being sent to the USB controller 126. The micro-controller 36 facilitates this operation by sending out a read command via CONTROL signals 142, 144 and 146.

The receiver circuit 324 also comprises a toggle button (not shown) which is used to alternate between the 400×300 and 100×100 image frame sizes for the image array 68. When a user pushes the toggle button, this will send a signal from the receiver module 34 to the transmitter module 32 (i.e. Bluetooth devices are bidirectional). In the future, the size of the image array 68 may be selected via the software program 40 and there may also be a wider selection of image frame sizes for the image array 68.

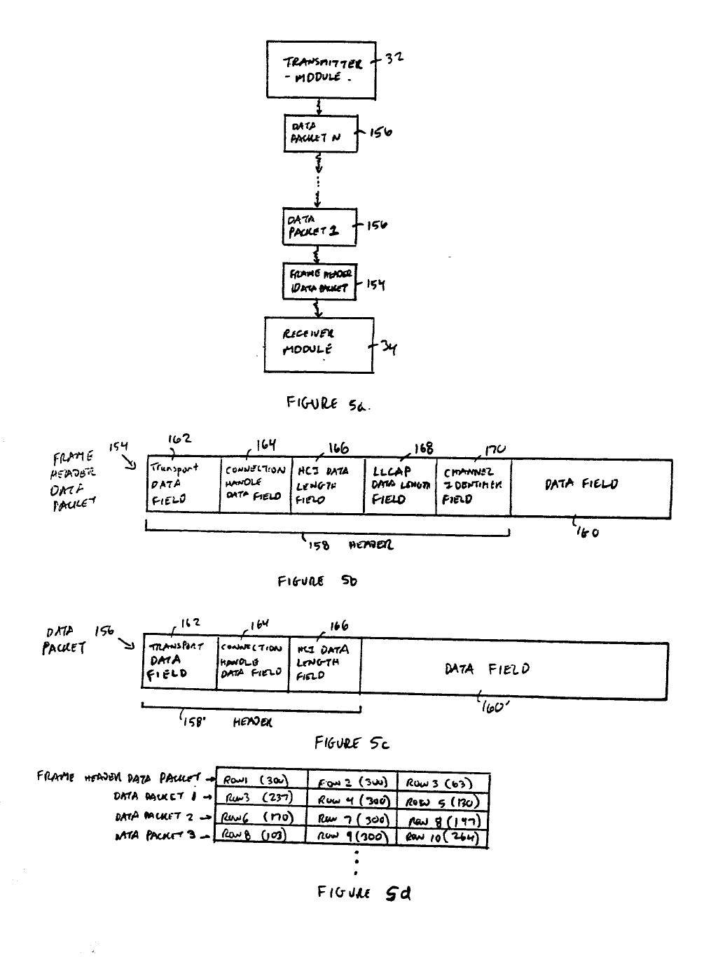

Referring now to FIG. 5a, data transfer between the transmitter module 32 and the receiver module 34 occurs via a plurality of data packets as previously mentioned. For a given image frame, a frame header data packet 154 is the first data packet that is sent followed by a plurality of data packets 156. The structure of these data packets 154 and 156 are adapted to conform with Bluetooth Specification 1.1. More specifically, each data packet is limited to a size of 672 bytes and comprises a header and a data field. Furthermore, the transfer of data packets is limited to payloads which each have a maximum size of 65,536 bytes. Accordingly, for an image array 68 having a size of 100×100 (i.e. 10,000 bytes), all of the data packets can fit within one payload. However, for an image array 68 having a size of 400×300 (i.e. 120,000 bytes), two payloads must be used. The payload is related to the size of the buffer in the Bluetooth device that temporarily stores transmitted data. The buffer acts in a FIFO (First In First Out) manner. Accordingly, the Bluetooth device must process a current payload before receiving another payload. However, a Bluetooth device may still receive 10 data packets while processing the current payload.

Referring now to FIG. 5b, the frame header data packet 154 comprises a header 158 and a data field 160. The frame header data packet 154 is sent at the beginning of image data transmission for each new frame of image data that is transmitted. The header 158 comprises a transport data field 162, a connection handle data field 164, an HCI data length field 166, an LLCAP data length field 168 and a channel identifier field 170. The transport data field 162 indicates the type of data (i.e. voice or other data) which is contained within the data field 160. The connection handle data field 164 specifies a handle number to identify the connection between the two Bluetooth devices that are communicating with one another. The HCI data length field 166 specifies the number of bytes of data in the data field 160. The LLCAP data length field 168 and the channel identifier field 170 together specify the size of the image array 68. This information is used by the micro-controller 36 and the software program 40 to correctly process all of the data packets associated with a given image frame. Since the frame header data packet 154 indicates the row and column sizes of the image array 68, horizontal and vertical pulse synchronization information does not need to be transmitted thus resulting in more efficient data transmission. The data field 160 comprises a portion of the image data obtained from the image sensor 20. Since, the header field 158 has a size of 9 bytes, there are 663 data bytes in the data field 160.

Referring now to FIG. 5c, the data packet 156 also comprises a header 158′ and a data field 160′. However, the header 158′ is 5 bytes long and the data field 160′ is 667 bytes long. The header 158′ also comprises the transport data field 162, the connection handle data field 164 and the HCI data length field 166 that are contained in the header 158 of the frame header data packet 154. Likewise, the data field 160′ also comprises a portion of the image data obtained from the image sensor 20. Since, the data field 160′ is at most 667 bytes long, a plurality of data packets 156 is needed for image data transmission since there are preferably either 10,000 or 120,000 bytes of image data that need to be transmitted.

The image data in the data fields 160 and 160′ are taken from the image array 68 (see FIG. 2a) in a sequential order starting from the topmost, leftmost portion of the image array 68 moving to the right to the end of the first row, down to the leftmost portion of the next row and so on and so forth. Since the column size of the image array 68 is either 300 or 100, more than one row of image data will be contained in the data fields 160 and 160′ of the packets 154 and 156. This is shown in FIG. 5d for the frame header data packet 154 and the next three data packets 156 that are transmitted having image data for an image array 68 of size 400×300.

The software program 40 controls the operation of the wireless video surveillance system 10. The software program 40 is approximately 2 MB in size and can be installed on most computers in use today. The software program 40 was written using Visual Basic and is adapted for use on a computer dedicated to video surveillance.

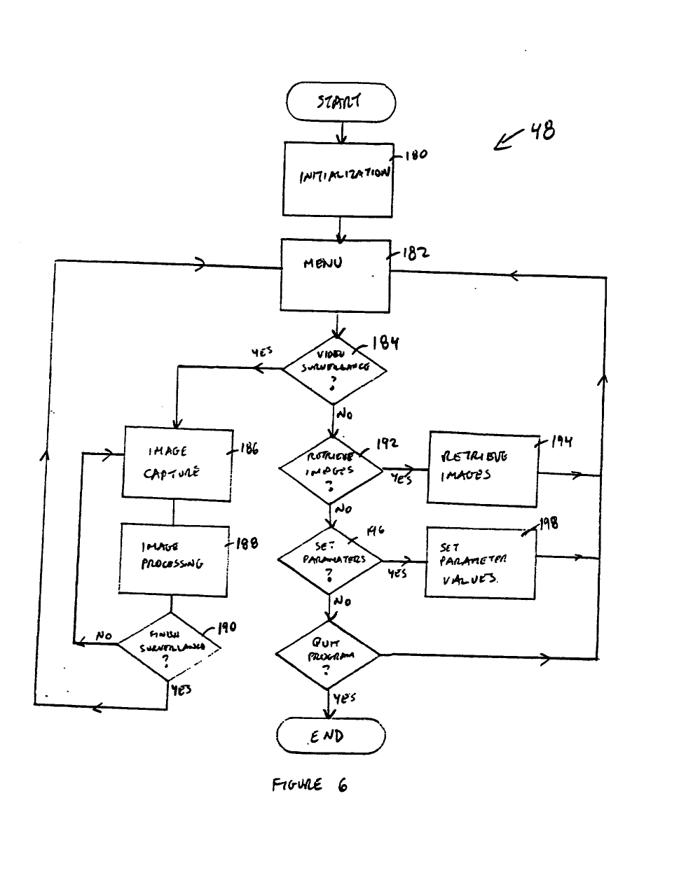

Referring now to FIG. 6, a flow diagram for the main module 48 is shown. The main module 48 is menu based with a graphical user interface that allows a user to perform several operations. The main module 48 begins at step 180 where software variables of the software program 40 and hardware components of the wireless video surveillance system 10 are initialized. In step 182, the user may access the menu which allows the user to start the wireless video surveillance system 10 in step 184, retrieve stored images in step 192 and set imaging parameters in step 196.

If the user chooses to activate the wireless video surveillance system 10, the main module 48 proceeds to perform steps 186, 188 and 190 in a loop structure. First, in step 186, a frame of image data is captured and transmitted from the wireless transmitter 22 to the temporary storage means 44 on the computer 26 as previously described. Next, in step 188, image processing is performed on the captured frame of image data using the image processing module 50. This process repeats itself until the user chooses to stop video surveillance.

Alternatively, the user may choose to retrieve stored images. In this case, the main module 48 proceeds to step 194 where images that are stored on permanent storage means 42 are retrieved. The images are identified by the date and time at which the image was captured. The user may choose to view a particular image or a sequence of images.

The user may also choose to alter the imaging parameters of the software program 40. In this case, the main module 48 proceeds to step 198 where the user may enter parameter values for the JPEG compression which is used to compress the images before storage. The user may also alter the frame speed at which a selected sequence of stored images are viewed. The user may also select a different color background while viewing stored images to enhance image contrast when a particular object is being viewed in the stored images.

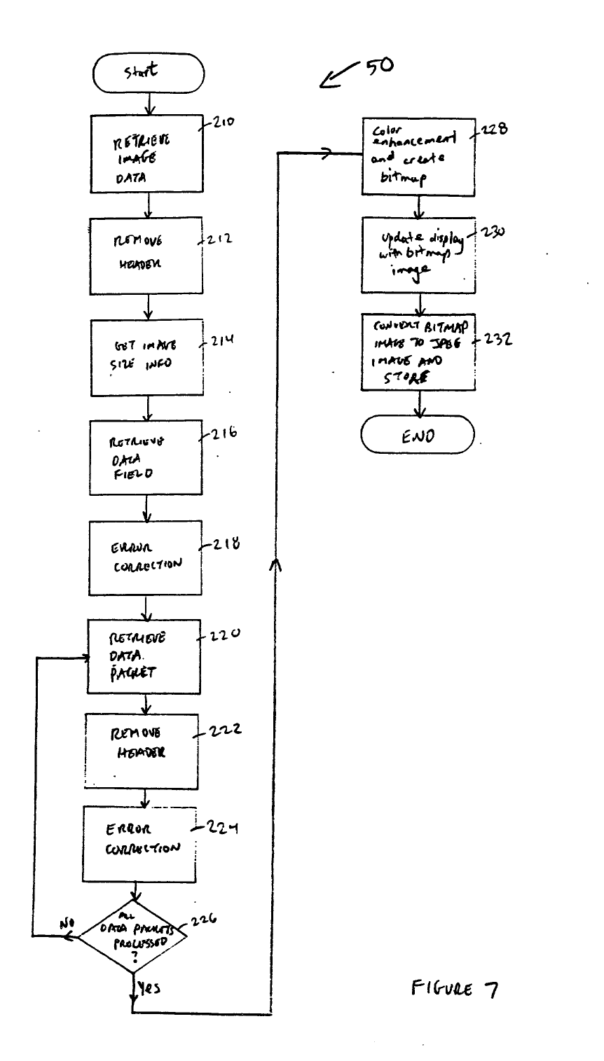

Referring now to FIG. 7, a flow diagram is shown for the image processing module 50 which operates on a given captured frame of image data. In step 210, the image data for the current image frame is retrieved from the temporary storage means 44. Next, in step 212, since the beginning of the image data comprises the frame header data packet 164, the header 158 is removed, In step 214, the row size and column size of the current image frame is obtained from the header 158. The row and column sizes are used to determine the number of data packets 156 which need to be retrieved from the temporary storage means 44. Furthermore, the row and column sizes can be used to create an image data matrix to organize the image data in the same fashion that the image data was originally oriented in the image array 68. The image size information is used instead of the conventional video image processing method of using horizontal and vertical sync pulses. The image data is then retrieved from the data field 160 of the header data packet 154 in step 216 and error correction is performed on this image data using error correction module 52 in step 218.

Next, in steps 220, 222, 224 and 226, each of the data packets 156 for the current image frame are retrieved and processed by removing the header 158′ of each data packet 156 and performing error correction on the image data in the data field 160′ of each data packet 156 via the error correction module 52. Once all of the data packets 156 have been processed, color enhancement is performed on the error corrected image data in step 228 and a bitmap image is formed. In step 230, the bitmap image is displayed on the display 46 of the computer 26 for visual inspection by the user. This will allow for real-time monitoring when the wireless video surveillance system 10 is in operation. The bitmap image is then converted to a JPEG image as is well known to those skilled in the art and stored in the permanent storage means 42 in step 232. The permanent storage means 42 may be a hard drive, a CD or the like. The conversion to a JPEG format allows for more efficient data storage.

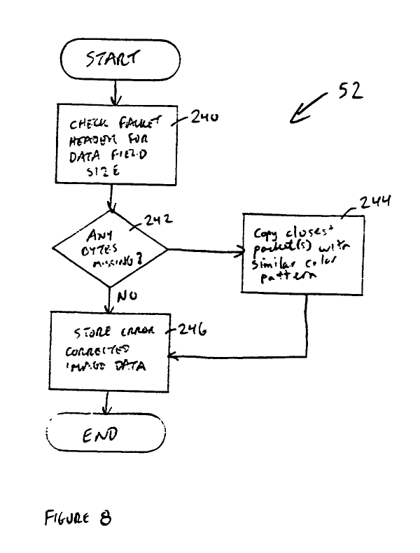

Referring now to FIG. 8, a flow diagram is shown for the error correction module 52. Error correction operates based on the concept of replacing all of the image data in the data field 160′ of an erroneous data packet 156 with image data from a previous data packet 156 that is error free and is similarly representative of the information that was represented by the erroneous image data. Error correction may be performed in this manner since, in general, sensor elements with similar color filters which are in close physical proximity to one another (e.g. on successive even rows or successive odd rows of the image array 68) will capture similar amounts of similar color. Alternatively, it is possible to design a system that would require re-transmission of the erroneous data packet. However, such a transmission method may prove to be a burden upon the system and its resources.

The error correction module 52 begins at step 240 where, for a given frame header data packet 154 or a data packet 156, the HCI data length field 166 is checked to determine the expected number of image data bytes that should be contained in the data field 160 or 160′. As previously mentioned, this number should be 663 for a frame header data packet 154 and 667 for a data packet 156 unless the data packet 156 is the last data packet which was transmitted in which case there may be less image data in the data field 160′. Next, in step 242, the error correction module 52 compares the actual number of image data bytes in the data field 160 or 160′ with the expected number of image data bytes indicated in the HCI data length field 166. Inequality in this comparison means that there are missing data bytes which is indicative of an error in data transmission. Accordingly, if there are not any data bytes missing then the image data is stored in an error corrected image data array in step 246 in the temporary storage means 44.

However, if there are data bytes missing in the data field 160′, then the error correction module 52, in step 244, copies the image data from the closest previous data packet which is error-free and has the same color scheme (i.e. recall FIG. 2b) to replace all of the image data from the data field 160′ of the erroneous data packet. This error corrected image data is then stored in the error corrected image data array in step 246. Image data from one or more data packets may be needed because of the nature in which the image data from the rows of the image array 68 are separated in consecutive data packets (i.e. recall FIG. 5d).

If there are missing data bytes in the frame header data packet 154, there are no previous data packets which can be used to copy image data since the frame header data packet 154 is the first data packet which is transmitted for a given image frame. In this case, the whole image frame is discarded and the image processing module 52 proceeds to process image data from the next image frame. In an alternative embodiment, the image data from latter data packets (i.e. data packets which occur after the erroneous data packet) may instead be used to provide image data which replaces the image data from an erroneous data packet.

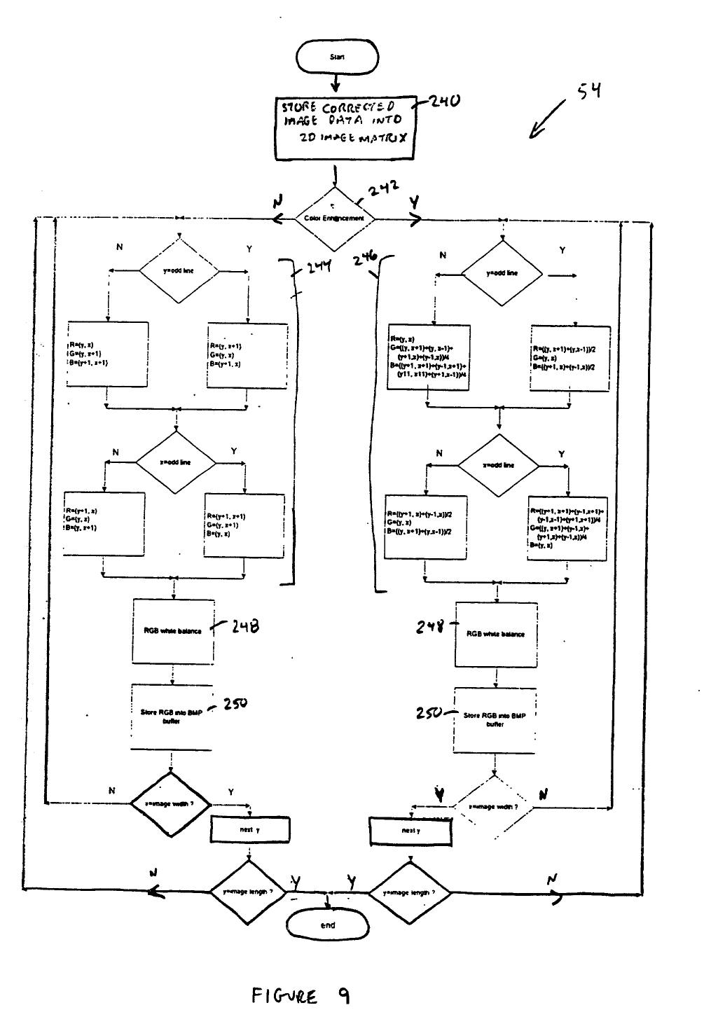

Referring now to FIG. 9, a flowchart of a preferred embodiment of the color enhancement module 54 is shown. Recall that the image data of the image array 68 contains color information organized as shown in FIG. 2b. Accordingly, the image data must be recombined in an appropriate fashion to approximate the scene from which the image frame was captured by the image sensor 20. To accomplish this, the color enhancement module 54 preferably uses the bilinear color interpolation method which is well known to a worker skilled in the art.

The color enhancement module 54 begins at step 240 where image data is taken from the error corrected image data array and stored in a 2D image matrix. Next, in step 242, the color enhancement module 54 determines whether the user wishes to perform color enhancement. If not, the color enhancement module 54 proceeds along the left side of the flowchart 244 where two nested loops are used to operate on each data value (i.e. pixel) from the 2D image matrix. For a given pixel from the 2D image matrix, the RGB colors are obtained in step 244. Next, in step 248, an RGB white balance algorithm is applied to the RGB colors for the pixel. The RGB white balance algorithm, which is commonly known to those skilled in the art, is used to enrich the colors for the current pixel. Next, in step 250, the RGB colors for the pixel are used to create a bitmap image. This process continues until all of the data from the 2D image matrix has been processed. Alternatively, if color enhancement is chosen, then the color enhancement module 54 proceeds along the right side of the flowchart where the bilinear color interpolation method is applied in step 246 to each pixel from the 2D image matrix. Steps 248 and 250 are then performed as previously described. In either case, the end result of the color enhancement module 54 is a color-enhanced image matrix in the form of a bitmap image which represents the scene from which the image sensor 20 originally captured the image data.

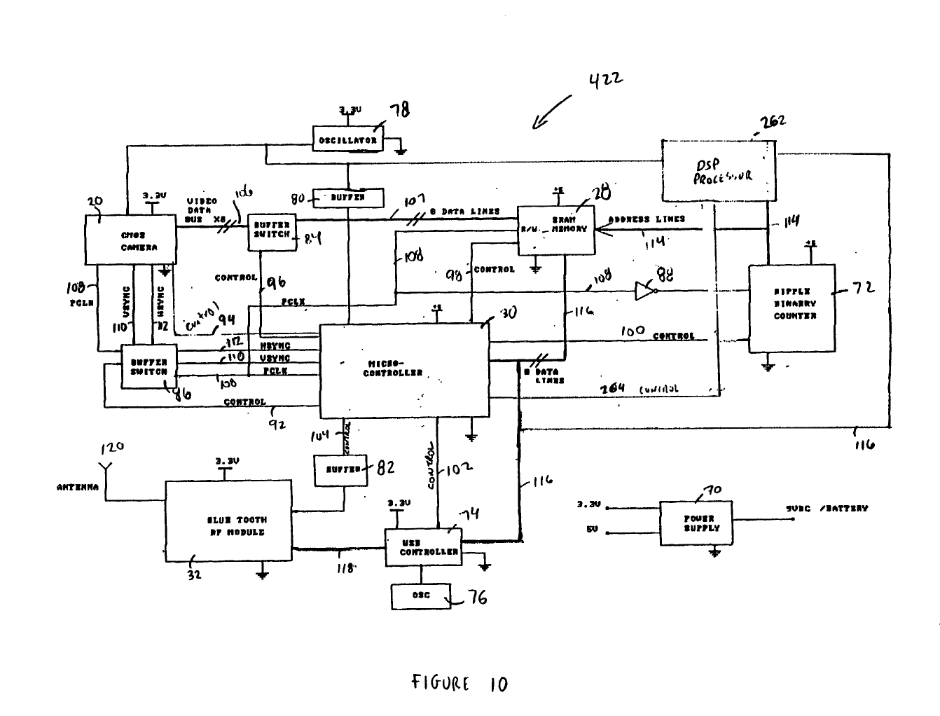

In an alternative embodiment of the wireless video surveillance system 10 some of the functionality of the software program 40 may be embedded in the hardware of the wireless transmitter 22. Referring now to FIG. 10, shown therein is an alternative transmitter circuit 422 to implement the wireless transmitter 22. The transmitter circuit 422 has the same components as the transmitter circuit 322 shown in FIG. 3 with the addition of a digital signal processor (DSP) 262 and a CONTROL signal 264. The DSP 262 may preferably be a TI 5402 DSP made by Texas Instruments™. Furthermore, the eight 1-bit data lines 116, the address lines 114 and the oscillator 78 are connected to the DSP 262. The DSP 262 is adapted to perform the function of the color enhancement module 54 as well as JPEG compression. In this fashion, the image data is color enhanced and compressed before being transmitted by the transmitter module 32. This will greatly increase the speed of the wireless video surveillance system 10 since JPEG compression may compress a 400×300 image having a file size of 120,000 bytes to an image having a file size of 20,000 bytes.

In operation, after all of the image data is stored in the memory 28, the micro-controller 30 would perform a read operation on the memory 28 to send the image data to the DSP 262. When the DSP 262 has received all of the image data, the DSP 262 will perform the color enhancement described in FIG. 9 followed by a JPEG compression to produce compressed, color-enhanced image data. The compressed, color-enhanced image data will then be stored in the memory 28. The micro-controller would then perform a read operation on the memory 28 to send the compressed, color enhanced image data to the USB controller 74. The rest of the wireless video surveillance system 10 would then work as previously described with the exception of the image processing module 50 since some of the image processing functions are already performed by the DSP 262. In addition, the error correction module 52 would be modified since compressed JPEG image data is now being sent in the data packets 156 instead of the uncompressed image data which was previously sent.

It should be understood that various modifications can be made to the preferred embodiments described and illustrated herein, without departing from the present invention, the scope of which is defined in the appended claims. For instance, instead of using the Bluetooth standard, another RF standard may be used such as the IEEE 802.11 standard. Accordingly, the use of a different RF standard would have an affect on the wireless transmitter and wireless receiver as well as the data packet structure. Furthermore, a compression method other than the JPEG compression method may be used. In addition, any suitable computing means may be used in place of the computer 26 and any suitable display means may be used for display 46.

1. A wireless video surveillance system, comprising:
a) an image sensor which captures image data, comprising a plurality of sensor elements arranged in an array having a number of rows and a number of columns;
b) a wireless transmitter operatively coupled to said image sensor for reading said image data and for transmitting said image data in a plurality of data packets, wherein each of said data packets has a data field comprising a portion of said image data and a header comprising information about the size of said portion of image data, wherein the first transmitted data packet further comprises information about the number of rows and the number of columns of said array;
c) a wireless receiver for receiving and reading said plurality of data packets; and,
d) a computer, operatively coupled to said wireless receiver for processing and storing said plurality of data packets and for generating and storing an image representative of said captured image data, wherein said computer utilizes said number of rows and said number of columns to facilitate the reception of said plurality of data packets and the generation of said image.

2. The wireless video surveillance system as claimed in claim 1, wherein said computer comprises an error correction module adapted to provide an error corrected image data array, wherein erroneous data packets having an erroneous portion of image data are corrected by replacing said erroneous portion of image data with an error-free portion of image data from at least one previously transmitted data packet, wherein the error-free portion of image data is similarly representative of the information that was represented by the erroneous portion of image data.

3. The wireless video surveillance system as claimed in claim 2, wherein said computer further comprises a color enhancement module adapted to produce said image by receiving and processing said error corrected image data array according to a bilinear color interpolation method and an RGB white balance method.

4. The wireless video surveillance system as claimed in claim 3, wherein said computer further comprises an image processing module adapted to receive said image, display said image on a display, compress said image and store said compressed image on a storage means.

5. The wireless video surveillance system as claimed in claim 1, wherein the wireless transmitter further comprises:
a) a transmitter module for transmitting said data packets;
b) a first micro-controller operatively coupled to said transmitter module to control the operation of said wireless transmitter;
c) a first memory operatively coupled to said image sensor to store said image data;
d) a first binary ripple counter operatively coupled to said first memory to provide memory address values at which said image data is stored; and,
e) a first USB controller operatively coupled to said first memory and said transmitter module to facilitate communication between said first memory and said transmitter module.

6. The wireless video surveillance system as claimed in claim 1, wherein said wireless receiver further comprises:
a) a receiver module for receiving said data packets;
b) a second micro-controller operatively coupled to said receiver module to control the operation of said wireless receiver;
c) a second memory operatively coupled to said receiver module to store said plurality of data packets;
d) a second binary ripple counter operatively coupled to said second memory to provide memory address values at which said plurality of data packets are stored;
e) a second USB controller operatively coupled to said second memory and said receiver module to facilitate communication between said second memory and said receiver module; and,
f) a third USB controller operatively coupled to said second memory and said computer to facilitate communication between said second memory and said computer.

7. The wireless video surveillance system as claimed in claim 1, wherein the wireless transmitter further comprises a digital signal processor, operatively coupled to said image sensor, to receive and process image data according to a bilinear color interpolation method and a compression method to produce compressed, color-enhanced image data.

8. The wireless video surveillance system as claimed in claim 1, wherein the computer further comprises a display to display said generated image.

9. The wireless video surveillance system as claimed in claim 1, wherein the computer further comprises a storage means to store said plurality of data packets and said generated image.

10. A method of performing wireless video surveillance, comprising the steps of:
a) capturing image data utilizing an image sensor having a plurality of sensor elements arranged in an array having a number of rows and a number of columns;
b) reading and transmitting said image data in a plurality of data packets utilizing a wireless transmitter, wherein each of said data packets has a data field comprising a portion of said image data and a header comprising information about the size of said portion of image data, wherein the first transmitted data packet further comprises information about the number of rows and the number of columns;
c) receiving said plurality of data packets; and,
d) processing said plurality of data packets and generating an image representative of said captured image data, wherein, said number of rows and said number of columns are used in receiving said plurality of data packets and generating said image.

11. The method as claimed in claim 10, wherein processing said plurality of data packets and generating an image comprises performing error correction on each transmitted data packet to correct erroneous data packets having an erroneous portion of image data according to the steps of:
a) removing the header of a data packet;
b) determining an expected number of image data bytes that should be contained in the data field of the data packet;
c) comparing the expected number of image data bytes to the size of the portion of image data contained in the data packet;
d) storing the portion of image data as error corrected image data if the comparison in step (c) is true; and,
e) identifying an erroneous data packet if the comparison in step (c) is false, replacing the erroneous portion of image data with an error-free portion of image data from at least one previously transmitted data packet and storing the replaced portion of image data in the error corrected image data array,
wherein, the error-free portion of image data is similarly representative of the information that was represented by the erroneous portion of image data.

12. The method as claimed in claim 11, wherein processing said plurality of data packets and generating an image further comprises performing color enhancement according to the steps of:
f) creating a 2D image matrix from the error-corrected image data array;
g) applying a bilinear color interpolation method to the 2D image matrix; and,
h) applying an RGB white balance method to the 2D image matrix after step (g) to generate said image.

13. The method as claimed in claim 10, wherein the method further comprises displaying said generated image.

14. The method as claimed in claim 10, wherein the method further comprises storing said plurality of data products, compressing said generated image and storing said compressed image on a storage means.

15. The method as claimed in claim 10, wherein the method further comprises the step of allowing a user to access a stored image.

16. The method as claimed in claim 10, wherein the method further comprises the step of allowing a user to access a sequence of stored images.

17. A system for performing error correction on transmitted data packets to correct data packets having an erroneous portion of image data wherein each packet has a header and a data field, said system comprising:
a) a storage means for storing said transmitted data packets; and,
b) an error correction module operatively coupled to said storage means for retrieving a data packet, removing the header of the data pocket, determining an expected number of image data bytes that should be contained in the data field of the data packet and comparing said expected number of image data bytes to the size of the portion of image data contained in the data packet, wherein, if said comparison is true, the portion of image data is stored and, if said comparison is false, the erroneous portion of image data is replaced with an error-free portion of image data from at least one previously transmitted data packet and stored wherein the error-free portion of image data is similarly representative of the information that was represented by the erroneous portion of image data.

18. A method of performing error correction on transmitted data packets to correct data packets having an erroneous portion of image data wherein each packet has a header and a data field, said method comprising the steps of:
a) removing the header of a data packet;
b) determining an expected number of image data bytes that should be contained in the data field of the data packet;
c) comparing the expected number of image data bytes to the size of the portion of image data contained in the data packet;
d) storing the portion of image data if the comparison step (c) is true; and,
e) identifying an erroneous data packet if the comparison in step (c) is false, replacing the erroneous portion of image data with an error-free portion of image data from at least one previously transmitted data packet and storing the replaced portion of image data,
wherein, the error-free portion of image data is similarly representative of the information that was represented by the erroneous portion of image data.
